(19) United States
(12) Patent Application Publication
(10) Pub. No.: US 2008/0241404 A1
(43) Pub. Date: Oct. 2, 2008

(54) Apparatus for Building a Three-Dimensional Article and a Method for Building a Three-Dimensional Article

(76) Inventors: Sandrine Allaman, Valence (FR); Rene Houben, Eindhoven (NL); German Enrique Knoppers, Eindhoven (NL); Ranjana C. Patel, Little Hallingbury (GB); Peter Sijtsma, Eindhoven (NL); Pascal Pierron, Valence (FR)

Correspondence Address: HUNTSMAN INTERNATIONAL LLC, LEGAL DEPARTMENT, 10003 WOODLOCH FOREST DRIVE, THE WOODLANDS, TX, 77380, US

(21) Appl. No.: 12/067,310

(22) PCT Filed: Sep. 19, 2006
(86) PCT No.: PCT/EP2006/066494

§ 371 Date: Mar. 19, 2008

(30) Foreign Application Priority Data
Sep. 20, 2005 (EP) 05108667.6

(51) Int. Cl. B05D 3/10; B05C 11/00; B05C 19/04

(52) U.S. Cl. 427/333; 118/308; 118/620

(57) ABSTRACT

The invention provides an apparatus for building a three-dimensional article in sequential cross-sectional layers, which apparatus comprises: a powder delivery system comprising one or more reservoirs for delivering a powder and a powder spreading system; a printing system for delivering a liquid; a build chamber comprising a outer wall, an inner wall and a build platform which is movable along the inner wall of the build chamber; and a powder recovery system; wherein the building chamber comprises a space defined by the upper portion between the inner wall and the outer wall of the building chamber and this space is in communication with the powder recovery system and/or the build platform is capable of releasing unused powder (directly) from the build chamber in a downward direction into the powder recovery system. The invention further provides a method building a three-dimensional article wherein use is made of said apparatus.

The present invention relates to an apparatus for building a three-dimensional article in sequential cross-sectional layers, and a method for building such an article wherein use is made of said apparatus.

There is increasing demand for the direct production of high strength, technically useful three dimensional articles from engineering CAD (Computer Aided Design) data. Numerous techniques have been proposed, largely yielding articles which are fragile and consequently of short term or intermediate use.

In U.S. Pat. No. 4,575,330 a method has been described of laser addressing of liquid and paste photopolymers. Though said method is highly successful, this technology requires laboratory standard post processing requirements and skilled operatives, and results in a state of art smooth surface but with somewhat limited possibilities for direct use articles.

Another technique is extrusion deposition and is, for instance, described in U.S. Pat. No. 6,869,559, and yields very good properties, e.g. thermoplastic properties, in the final article. However, the process is slow and requires wet processing to remove support structures.

In U.S. Pat. No. 5,136,515 a direct jetting system using curable fluids has been described. These are fast systems, but all require post processing and removal/disposal of support structures.

In U.S. Pat. No. 4,938,816 a powder based system is described wherein use is made of a high power CO₂ laser to sinter the powders. Such powder based systems are of interest because these can be self-supporting as the three dimensional article is being formed. Although laser sintering can yield high strength article approaching true thermoplastics, the process is slow and the resultant surface quality is rough.

Another powder based system uses binder jetting processes, largely based on aqueous jetted materials and has, for instance, been described in U.S. Pat. No. 5,204,055. This system is more rapid but results in fragile models which require further infiltration processes to achieve high strengths.

In WO 02/064354 A1 a three-dimensional structured printing process has been described wherein subsequent layers of powder material are applied on top of each other, whereby the respective powder layers contain a reactive or active component which components react on contact to form a solid lamina in the required pattern, which is repeated until the desired solid article is formed.

Many processes for building three-dimensional articles are conventionally carried out in an apparatus that comprises a powder spreading system, a printing system for delivering a binder material, a building chamber for forming the desired article, and a powder removal system, whereby excess powder from the powder spreading system is fed into the powder recovery system via an opening slit arranged at one end of the powder spreading system and build chamber. Such an apparatus has, for example, been described in US 2001/0045678 A1 or in WO3016067A2.

Once fabricated, the formed three-dimensional articles then have to be extracted from the powder bed. This is a difficult process and care has to be taken so as not to break the three-dimensional article whilst removing. The following art describes some ways:

US2004/084814 describes a complicated powder removal system for a 3D printer involving powders, wherein the formed object is removed from the powder bed through a system of vacuuming and introduction of pressurised air,

US2002/0090410 describes another complicated powder removal system using a processing chamber which has air blowing inlets and suction outlets.

US2001/0045678 describes a powder removal section in which the formed article within the powder bed is moved to a powder removal section. WO2005/025780 describes a powder removal in a laser sintering (SLS) type machine, showing again a powder suction area as well as a cooling section. Preferably, cooling is not involved in present invention.

However, such machine designs leave considerable room for improvement since the powder spreading system becomes quite messy due to excess powder during the fabrication and extraction of the three-dimensional article, which complicates the production process. In addition, there is a considerable production of waste material that cannot be re-used. Moreover when using fully curable fluid resins, such control mechanisms are essential in order to prevent the contamination of the resin dispensing device, e.g. an ink jet print head.

An object of the present invention is to provide an apparatus for building a three-dimensional article which apparatus is relatively simple and at the same time facilitates a clean production process, whereby unused powder material can be re-used in an efficient manner. This apparatus is especially useful with fully curable fluids being delivered to the powder bed, to be integrated into/with the powder forming high performance accurate layered objects.

It has now been found that this can be realised when use is made of a build chamber of which a considerable part is in contact with a powder recovery system, especially which powder recovery system is covered by a surface around the build chamber, such surface being a filter or mesh through which the excess powder is readily pushed into the powder recovery unit. The surface moreover has a shape which allows the user to process easily, e.g. remove further powder, from the formed three-dimensional article. Preferably, such apparatus is free from complicated system of aspiration by inlet and suction ports leading to a recovery system involving aspiration or vacuum cleaning of the unused powder, with the risk to induce disturbance in the machine. Preferably, the unused powder is recovered mainly by gravity. Apparatus involving openings in the side walls of the building chamber can be easily obstructed and need a complicated vacuum system to evacuate the unused powder. Therefore, preferably, only the upper portion and the bottom portion of the build chamber comprise openings in communication with the powder recovery system. This allows the unused powder to be recovered easily and gently, by gravity. Preferably the build chamber is located within the powder recovery system.

The invention therefore provides an apparatus for building a three-dimensional article in sequential cross-sectional layers, which apparatus comprises:

a powder delivery system comprising one or more reservoirs for delivering a powder and a powder spreading system;

a printing system for delivering a liquid;

a build chamber comprising an upper portion, a bottom portion, an inner wall and a build platform on the bottom structure which platform is movable along the inner wall of the build chamber;

and a powder recovery system;

wherein:

the build platform of the build chamber has openable (i.e. which can be opened), collapsible or removable parts capable of releasing unused powder directly from the build chamber in a downward direction into the powder recovery system and

the build chamber comprises an outer wall and, on the upper portion of the build chamber, the space between the inner wall and the outer wall comprises openings in communication with the powder recovery system.

The invention also provides an apparatus wherein the build chamber is enclosed within the powder recovery system.

Preferably, more than 25% of the space comprised between the upper portions of the inner wall and the outer wall is in communication with the powder recovery system. Preferably, at least 50%, more preferably at least 75% of said space is in communication with the powder recovery system

Then a considerable part is in contact with a powder recovery system, both during the layer wise fabrication and subsequently for powder removal from the 3-dimensional article. Preferably, the communication between the said space and the powder recovery system is direct.

In the rest of the description, the space located between the upper portion of the inner wall and the upper portion of the outer wall, is also called “upper portion of the build outer wall of the build chamber” or even “the outer wall of the build chamber”.

The invention also provides an apparatus for building a three-dimensional article in sequential cross-sectional layers, which apparatus comprises: a powder delivery system comprising one or more reservoirs for delivering a powder and a powder spreading system; a printing system for delivering a liquid; a build chamber comprising an outer wall, an inner wall and a build platform which is movable along the inner wall of the build chamber; and a powder recovery system; wherein the building chamber comprises a space defined by the upper portion between the inner wall and the outer wall of the building chamber and this space is in communication with the powder recovery system and/or the build platform is capable of releasing unused powder (directly) from the build chamber in a downward direction into the powder recovery system. The invention further provides a method building a three-dimensional article wherein use is made of said apparatus

The present invention also relates to an apparatus for building a three-dimensional article in sequential cross-sectional layers, which apparatus comprises: a powder delivery system comprising one or more reservoirs for delivering a powder and a powder spreading system including preferably a roller or spreader compacter (also defined as powder recoater) to spread and compact the powder; a printing system for delivering a liquid; a build chamber wherein the article is built comprising a outer wall, an inner wall and a build platform which is movable along the inner wall of the build chamber; and a powder recovery system; wherein the build platform is capable of releasing unused powder directly from the build chamber in a downward direction into the powder recovery system.

The present invention further relates to an apparatus for building a three-dimensional article in sequential cross-sectional layers, which apparatus comprises: a powder delivery system comprising one or more reservoirs for delivering a powder and a powder spreading system; a printing system for delivering a liquid; a build chamber wherein the article is built comprising a outer wall, an inner wall and a build platform which is movable along the inner wall of the build chamber; and a powder recovery system; wherein more than 25% of “the upper portion of the build outer wall of the build chamber” is in communication with the powder recovery system.

In addition, the present invention also relates to an apparatus for building a three-dimensional article in sequential cross-sectional layers, which apparatus comprises: a powder delivery system comprising one or more reservoirs for delivering a powder and a powder spreading system; a printing system for delivering a liquid; a build chamber wherein the article is built comprising a outer wall, an inner wall and a build platform which is movable along the inner wall of the build chamber; and a powder recovery system; wherein more than 25% of the outer wall of the build chamber is in communication with the powder recovery system; and wherein the build platform is capable of releasing unused powder in a downward direction into the powder recovery system.

In another embodiment, the present invention relates to an apparatus for building a three-dimensional article in sequential cross-sectional layers, which apparatus comprises: a powder delivery system comprising one or more reservoirs for delivering a powder and a powder spreading system; a printing system for delivering a liquid; a build chamber wherein the powder spreading system involves preferably a roller spreader/compacter which is cleaned at the end of its spreading function by e.g. a moveable, preferably shaped, scrapper, or brush, or vacuum device, such that the need for a overflow directly from the build station surface is avoided. In this situation, the recoater would run directly over a solid surface, rather than over a powder recovery slot. This method is particularly important in order to avoid contamination of the resin delivery mechanism by any excess powder being thrown up by the recoater mechanism.

In above embodiments, the build chamber has preferably a surrounding area, preferably at the same level as the build chamber top surface, which comprises a mesh or filter surface, such that any/all powder overflow is safely and cleanly brushed into the powder recovery unit.

Preferably, the build platform is capable of releasing the unused powder directly from the build chamber in a simple downward direction into the powder recovery system. This means that unused powder can be released from the build platform whilst the build platform is maintained within the build chamber. In other words, the build platform does not need to be removed from the build chamber before unused powder can be released from the build platform.

The use of the apparatus in accordance with the present invention facilitates improved production processes for building three-dimensional articles. Moreover, a considerably simplified apparatus to fabricate three dimensional articles is provided, whereby the need for supports is removed, and unused powders can be fully recycled.

In the context of the present invention unused powder is defined as powder that is not included in the article to be built, i.e. it may include fresh powder as well as recycled powder.

In the various embodiments of the apparatus according to the present invention more than 25% of the outer wall of the build chamber is in communication with the powder recovery system. This means that unused powder material can very attractively be removed from the build platform and passed to the powder recovery system. Preferably, at least 50% of the outer wall of the build chamber is in communication with the powder recovery system. More preferably, at least 75% of the outer wall of the build chamber is in communication with the powder recovery system.

Suitably, the more than 25%, more preferably the at least 50%, and most preferably the at least 75% of the outer wall of the build chamber is in direct communication with the powder recovery system, which means that unused powder material can directly be passed from the build platform to the powder recovery system.

In the build chamber a number of articles can be formed at the same time, which articles may differ from each other in terms of shape and/or composition.

An advantage of the present apparatus is that a considerable part of the powder recovery system is in direct communication with the build chamber thereby creating sufficient space for cleaning the article once it has been prepared and removed from the build platform. For these cleaning purposes, said space may contain mechanical means for stirring or moving the article to remove any excess powder.

The build platform can suitably have the form of a square, rectangle, a circle or an oval.

Suitably, the printing system of the apparatus in accordance with the present invention comprises one or more nozzles.

Preferably, the printing system comprises a plurality of nozzles. More preferably, the nozzles form part of an inkjet printer or a device including a set of nozzles generally equivalent to an inkjet print head. Preferably, the nozzles operate on the principles of piezo inkjet technology. Preferably, the printing system comprises two or more print heads. Suitable examples of inkjet print heads to be used in accordance with the present invention include those commercially available such as, for instance Xaar (Leopard, XJ-series, Omnidot-series) and Spectra/Dimatix (Nova, Galaxy, SL-series, M-class) and Trident (PixelJet, UltraJet).

Preferably, the size of the nozzle openings is the range 10 to 100 μm and/or the size of the applied droplets is in the range 5 to 100 μm, although the nozzle openings may be smaller than 1 μm, even as small as a few nanometres, thus allowing correspondingly sized droplets to be applied.

The powder delivery system of the apparatus according to the present invention comprises one or more reservoirs for delivering a powder. Preferably, the powder delivery system comprises a plurality of reservoirs for delivering a powder.

It will be understood that different types of powder material can be used in the respective layers. Hence, the respective reservoirs may each contain a different type of powder material. Preferably, the respective reservoirs contain a similar type of powder material.

Suitably, the build platform of the build chamber comprises an upper structure provided with openings and a bottom structure that can be opened or removed to release unused powder through the openings of the upper structure. Preferably, the upper structure comprises a mesh tray, a grill, a grid, or a louvered structure.

Suitably, the bottom structure of the build platform comprises parts that are openable, collapsible or removable. Collapsible parts may suitably comprise flaps. Preferably, the bottom structure comprises parts that are openable, for instance parts that can be opened by turning them around their rotary shafts. Preferably, the parts that are openable, collapsible, or removable can be vibrated to further help in removal or separation of the powder from the formed object.

The build platform may suitably be connected to a surrounding surface which covers and protects the rest of apparatus, such surface being porous to the powder. This surround allows easy capture of overflow powder from the build chamber and direction of the overflow powder by filtering/brushing into lower part of the apparatus. The build platform can be connected to a means for mechanically stirring or moving the platform, thereby allowing excess and thus unused powder to be removed from the article to be built.

The apparatus according to the present invention may suitably comprise a means for curing the article to be built. Preferably, such means for curing the article to be built is an electromagnetic radiation-based system.

Suitably, the electromagnetic radiation-based system comprises a UV lamp, or a visible or infra-red light radiation unit, or microwave unit. Preferably the UV source is a UV light emitting device array (LED), e.g. as available from Phoseon Inc, example being RX10 or RX20.

Preferably, the applied resin, or the powder or the applied resin-powder combination is suitably sensitised to react with the emission of such curing devices, in a manner that fast curing (preferably less than 10 secs per layer sequence) is achieved.

Preferably, the means for curing the article to be built is attached to the powder spreading system. More preferably the means for curing, means for powder spreading and means for applying the fully curable resin are integrated in one carriage, thus considerably simplifying the design.

The powder recovery system of the apparatus in accordance with the present invention suitably comprises a conduit for transporting unused powder and a powder carrier screw for moving unused powder through the conduit or it comprises a conduit for transporting unused powder and a vacuum pump for moving unused powder through the conduit. In another embodiment the powder recovery system comprises a conveyer belt for moving unused powder.

In a very attractive embodiment of the present invention, the apparatus is equipped with a container to receive the print head purged fluid. Once present in the container the fluid can be cured and subsequently easily be disposed of, which is, for instance, very attractive for environmental reasons. Preferably, such a container is transparent and the curing of the fluid is carried out with electromagnetic radiation-based system. There could be other triggering methods to convert the jetted fluid into a safely disposable solid for example by some chemical or thermal means.

Suitably, the powder recovery system comprises a filter or a sieve for filtering or sieving unused powder.

Preferably, the printing system and the powder spreading system are connected to the same guiding means. Besides lower hardware costs, this enables parallel functioning of both to increase building speed, as well as higher precision due to exact linearity of both.

The present invention also relates to a method or process for building a three-dimensional article in sequential cross-sectional layers in accordance with a model of the article, which method comprises the steps of:
defining a layer of a powder material;
applying a liquid reagent to the layer of powder material so defined, in a pattern corresponding to the respective cross-sectional layer of the model;
repeating these steps to form successive layers so as to obtain a three-dimensional article;
optionally curing the three-dimensional article thus obtained; and
recovering the (cured) three-dimensional article;
   in which method use is made of an apparatus according to the present invention.

By means of the present method the formed article can directly be delivered as a directly handle able article.

Such an article can have variable colour, mechanical, optical and electrical and other properties, such as stiffness, toughness, transparency, conductivity, biocompatibility including DNA specific properties, magnetic etc.

Preferably, in the method according to the present invention the powder material comprises a first reactive component and the liquid reagent comprises a second reactive component, the second reactive component being capable of either reacting with the first reactive component or facilitating the first reactive component to react with itself.

Where the liquid reagent combines with the powder, the liquid reagent and powder will react to form a solid structure. The solidification can occur immediately after the resin has contacted the powder or may occur after exposure to electromagnetic or ultrasound irradiation, e.g. a UV curing step.

Preferably, the second reactive component acts as a catalyst to facilitate cross-linking of the first reactive component. Preferably, the powder substantially comprises the first reactive component. The reaction may be in the form of swelling and tackification of the powder particles and then actual chemical reaction with the liquid reagent. It has been found that the system according to the invention can allow the formed article to be relatively robust since the reactive powder and the liquid reagent react chemically to form a new chemical component. Chemical bonds can also form between layers and so there may be no dependence on the mechanical bonding relied upon in the prior art systems. The articles produced are void-free and free of powder relics within the structure. The powder undergoes rapid dissolution on contact with the liquid reagent. This produces a viscous, practically immobile resin which will retain its shape until curing is complete.

Preferably, the liquid reagent comprises in addition a viscosity lowering diluent, preferably a curable diluent. The use of such a diluent enables the liquid reagent to be printed out of smaller bore nozzles, without the need to raise the temperature, thereby achieving a superior resolution. In addition, it improves penetration of the liquid into the body of the powder, thereby achieving a more homogeneous distribution of the reactants while also enabling rapid aggregation of the powder, thus improving resolution and further allowing the liquid reagent to react firmly with the surface of and interior of the powder.

The powder layers may all be of the same formulation. However, different powder materials can also be used for different layers, or different powder materials can be used in the same layer.

Different liquid reagents may also be used, either at different locations on the same layer or on different layers. The liquid reagent can be applied using a linear array of nozzles which are passed over the powder layer. Thus different liquids can be supplied to different nozzles and/or different liquid reagents can be applied in respective sequential passes, either over the same powder layer or succeeding layers. Thus, different properties in terms of strength and flexibility can be established in a particular layer or among the various respective layers. The process may include a further step of curing the article by means of irradiation. The article may be irradiated pixel by pixel, line by line or layer by layer, and/or after several layers have been formed, and/or after all the layers have been formed.

Suitably, the formed layer may be up to 300 μm in thickness, though more commonly they might be up to 200 μm. Thin layers down to 80 μm or 50 μm may be achieved and possibly even thinner layers having a thickness in the range of from 1 to 30 μm. The powder comprises preferably individual powder particles which in majority have a size in the range of from 1 to 70 μm. More preferably, the powder comprises individual powder particles which in majority have a size in the range of from 20 to 50 μm, and even more preferably in the range of from 20 to 40 μm. The finer the powder, finer is the attainable resolution and accuracy in the formed object.

Combination of such powder sizes is also envisaged to facilitate a variety of properties to be attained. Examples of such properties include powder dissolution rate, and ultimate mechanical strength.

Preferably, the powder comprises reactive organic or organometallic polymers, oligomers or monomers, and the liquid reagent comprises a curable resin. The powder may also contain an organic or inorganic filler, a pigment, nanoparticles, a dye and/or a surfactant.

The powder can be a thermoplastic material, for instance, polyvinylacetal, a surface-treated powder such as treated polypropylene, ABS or polycarbonate, or a thermosetting powder such as an epoxy powder.

The powder can also comprise a treated filler having reactivity on the surface, for instance, an epoxysilane treated filler such as silica. The powder may also comprise acrylate, epoxidised, aminated, hydroxylated organic or inorganic particles, present as such or as composite with a polymer.

Examples of suitable powders include polyacrylic acid, poly (acrylonitrile-co-butadiene), poly (allylamine), polyacrylic resins with functional acrylate groups, polybutadiene, epoxyfunctionalised butadienes, poly (glycidyl (meth) acrylate), polyTHF, polycaprolactone diols, HEMA, HEA, maleic anhydride polymers, e.g. styrene-maleic anhydride, polyvinylbutyrals, polyvinyl alcohol, poly (4-vinylphenol), copolymers/blends of these compounds, and any of these compounds end capped with epoxy, vinyl ether, acrylate/methacrylate, hydroxy, amine or vinyl moieties, as appropriate.

The liquid reagent may include compounds which can undergo condensation reactions triggered either by thermosetting reactions such as epoxy/amine or isocyanate/polyol/amine, or by electromagnetically triggered cationic systems such as epoxy plus cationic photo-initiators (sulfonium, iodonium or ferrocenium), salts or radically cured systems such as acrylates, urethane acrylates, epoxy-acrylates, plus radical photoinitiators, benzophenone, Irgacure 184, alkylborates iodonium salts.

The liquid reagent can suitably be an epoxy, acrylic, isocyanate, epoxy-acrylate, amino, or hydroxy-based composition. The liquid reagents may be neat liquids, diluted liquids or emulsions in water. Examples of suitable liquid reagents include one or more of cycloaliphatic epoxy optionally with diol/triol/polyol moieties, glycidyl epoxy, epoxidised polybutadiene, aliphatic/aromatic amine, methacrylate, acrylate, styrene/substituted styrene, acrylonitrile, vinyl ether, alkenes e.g. isoprene, oxetane, organic acids or esters, organic acid halides, propenyl ether epoxides, siloxane epoxy or oxetanes, allyl nopol ether epoxide, and cycloaliphatic epoxy alcohols. These compositions may be mono-or multifunctional.

The liquid reagent may contain colloidal or nano-particles of ceramics, organic micro or nano particles, micro or nano metals and their alloys. The viscosity of the liquid reagent is suitably in the range of from 2 to over 500 mPas at room temperature and will have a much lower viscosity at higher operational temperatures. Preferably, the viscosity of the liquid reagent is in the range of from 2 to 30 mPas, at the jetting temperature. Low melting metallic alloys maybe delivered, e.g. by jetting, directly onto/into the powder, thus producing metallic tracks continuous or co-juxta positioned with the liquid curable reagents.

The liquid reagent can be printed or micro-sprayed onto the powder. Two or more liquid reagents may be printed or sprayed simultaneously from adjacent print heads such that the liquid reagents combine either in flight or on/around the surface of the reactive powder.

Preferably, the diluent is present in an amount in the range 30 to 60% by volume, more preferably to 30 to 40% by volume, based on total volume of liquid. Preferably, the first reactive component represents 30 to 80% by weight of the powder, more preferably 50 to 70% by weight, based on total weight.

The process lends itself very conveniently to the production of articles from a digital representation held by a computer, and is particularly suitable for use with CAD systems. Hence, the model is preferably a digital model. An article can thus be designed using CAD software, the digital information can be converted to a series of laminae in digital form and the digital representation of the laminae can be used to control the delivery of the liquid sequentially on to successive layers of the powder, in order to reproduce the article in 3-dimensions. The techniques can be used for rapid prototyping and even small scale rapid manufacture.

The produced object can be used as an actual technically functional part or be used to provide a proof of the CAD files before actual production. The technique is also suitable for in-line production use as layered encapsulants in the electronic field and for formation of micro-printed electronics and optics. The technique may also be useful in forming multi-layer structured films with polarising optical or wave guiding effects.

It will be appreciated that by using the method according to the present invention, it is possible to build up three dimensional articles in the form of laminated blocks or items with complex shapes. By varying the characteristics across the layers including layer thickness, as they are formed, optionally on a micro-scale, it is possible to instil at least a functionality in the finished article. This functionality can take many forms, examples of which include electronic circuits and optical components. In the case of electronic circuits, the techniques of the invention offer a method of producing intricate circuits of microscopic size. Preformed circuits can be embedded in the layers. In the case of optical components, the invention enables the optical properties of a component to be varied layer by layer and across each layer, and each layer can be of varying thickness, thereby enabling complex optical multi-layer films to be produced. It is also possible to build the component on to a substrate which is then retained as part of the final finished article. Such a substrate might be a glass or plastics sheet which could for example form part of an optical component.

Preferably, in the powder recovery system an under pressure is applied. Thus, powder contamination of the print heads can attractively be reduced or avoided.

The method according to the present invention enables the forming of articles with much improved mechanical properties and colour patterns. The articles obtained in accordance with the present method have a high strength, a smooth surface quality, and they are ready for use shortly after fabrication, with no production of waste material and an efficient re-use of unused powder material.

Using the powder Mowital B60T (cryo ground to produce a finer powder particle distribution centering at 45 microns) and the fully curable jettable resin described in WO 02/064354 A1, example 11, a dog bone part was fabricated from 30 layers of powder, each layer being 100 μm. After appropriately programmed application of the fully curable resin to the powder layer, using a Spectra Novajet, the resulting powder-resin composite was cured using an UV LED array, Phoseon RX10 (5 secs) positioned 5 mm above the surface of the powder layer). The above layer was recoated with fresh powder, applied with the appropriate programmed amount of the jetting resin and cured using the UV LED device. This sequence was repeated to yield the dog bone made up of 30 layers. The formed object was removed from the powder bed immediately (preferably less than 30 secs, more preferably less than 10 secs) after fabrication, without damage. High tensile strength was achieved by the process (>25 MPa). Young's Modulus was estimated as 1.43 Gpa, which is comparable to many engineering polymers.

The process or apparatus according to the invention permits to obtain engineering polymers without any further processing.

Preferably, the build chamber is connected to the printing carriage using a subframe, which is preferably connected to the machine frame using means which dampen the transfer of vibrations to the subframe.

Preferably, the printheads extend on the full width of the inner part of the build chamber i.e. the space located between the inner walls of the building chamber.

Suitably, the powder spreading system uses an independent scanning unit comprising a metering device behind a counter rotating roller, in which the metering device receives certain amount of powder from a stationary powder housing (powder hopper). The powder housing can be remote from the printing system in order to prevent powder contamination of the jet print heads.

The printing system suitably scans the powder layer from opposite direction to the powder spreader and comprises a precision droplet generating system, e.g. drop on demand inkjet print heads or continuous print heads. Preferably, the printing system comprises more than one print head, more preferably more than two print heads. When not scanning, the print heads can be parked in a unit which is shielded from the curing mechanism, e.g. stray electromagnetic or ultrasonic radiation. When parked, the print head can be cleaned/purged as required, within the parking unit. The housing unit of the printing system is suitably positioned remote from the powder housing unit.

The means for providing electromagnetic radiation (radiation unit) can suitably be positioned above the powder layer, with clearance for operation of the powder spreader and liquid reagent dispenser. The radiation can suitably be delivered across the whole layer surface, and is preferably even across the whole layer surface.

The build platform of the build chamber has a bottom structure which opens to facilitate removal of unused powder through a mesh tray, a grill, a grid, or a louvered structure. Vibration of the build platform can be used to remove further amounts of unused powder material. After removal of the unused powder, the build platform can move up to deliver the finished article.

Unused powder can attractively be transferred to the one or more reservoirs for delivering a powder material. Said reservoirs can also be recharged with fresh powder using cartridges.

The articles built in accordance with the present invention have suitably a tensile strength of greater than 20 MPa, preferably greater than 30 MPa, and more preferably greater than 40 MPa. The articles also present a good surface quality. Preferably, they have surface smoothness properties such as, for example, a surface variation of less than 50 μm, preferably less than 10 μm, and more preferably less than 1 or 2 μm. Surface roughness measurement is made on a sample of 10 mm length, the surface of which is magnified 2000 times to assess surface smoothness. The difference between the maximum height and the minimum height of surface roughness is noted as microns (the tiny wave). The tiny wave is preferably less than 1 μm.

### BRIEF DESCRIPTION OF THE FIGURES

FIG. 1: Apparatus side view

FIG. 2: Apparatus top view

FIG. 3a: Carriage side view (scanning printheads)

FIG. 3b: Carriage top view (scanning printheads)

FIG. 3c: Carriage side view (fixed printhead bar)

FIG. 3d: Carriage top view (fixed printhead bar)

FIG. 4: Frame subframe

FIG. 5: Apparatus variant, cross-sectional view

FIG. 6: Apparatus variant, three-dimensional cross-sectional view.

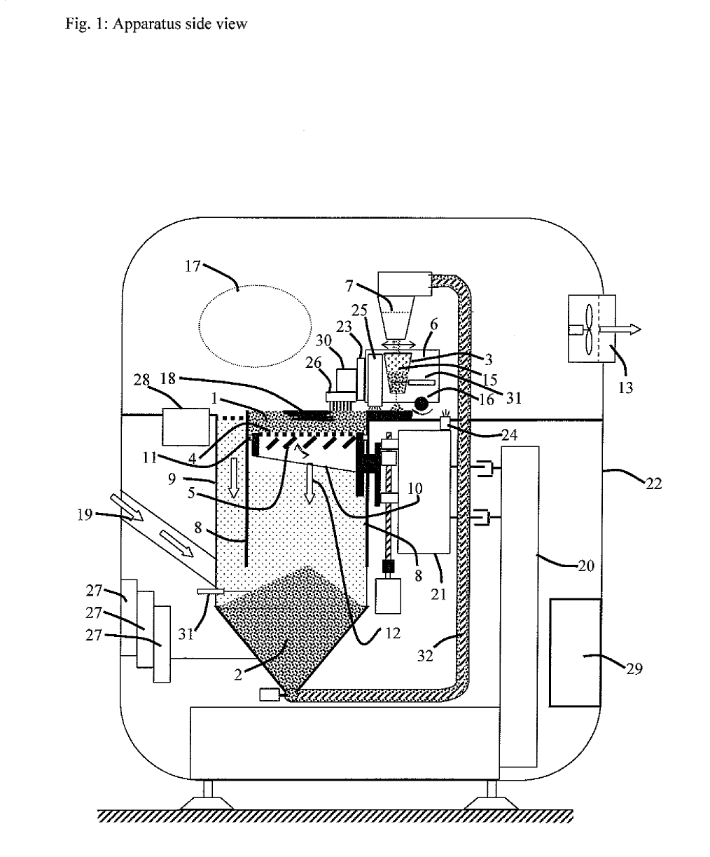

Explanation of numbers in FIGS. 1 to 4

### NUMBER DESCRIPTION

1 Build chamber

2 Powder reservoir

3 Powder doser

4 Mesh tray (coarse filter mesh, separation of powder from the part)

5 Louvered structure

6 Carriage

7 Fine filter mesh (separation of powder from contaminants for reuse)

8 Build chamber inner wall

9 Build chamber outer wall

10 Build platform

11 Build platform seal

12 Unused powder flow

13 Air vent with filter

14 Vibration dampeners

15 Powder doser storage vessel

16 Powder spreader roll

17 Article inspection area

18 Three dimensional article

19 Powder refill shute

20 Frame

21 Subframe

22 Covering

23 Printhead cradle

24 Powder spreader cleaner

25 U Lamp

26 Printhead

27 Binder reservoir

28 Printhead cleaner

29 Electrical control cabinet

30 Printhead reservoir

31 Powder level sensor

32 Powder transport screw

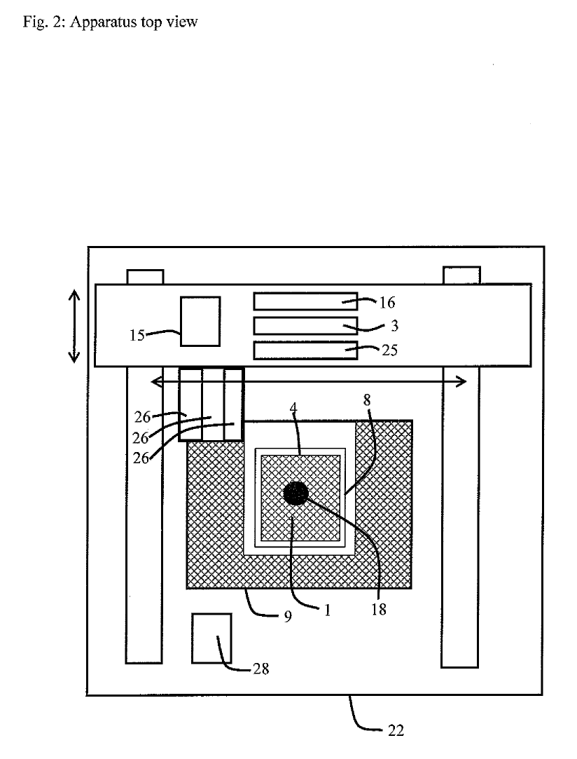

In FIGS. 1 and 2 the powder delivering system comprises a reservoir for delivering a powder material (2), a powder transport system (32) leading to a filter mesh (7) to a powder doser (3), a spreading system which comprises a roller (16) for applying the powder into the build chamber (1). The build chamber (1) comprises an inner wall (8) and an outer wall (9), a build platform (10) which is movable along the inner wall of the build chamber for example by means of piston. The build platform is made up of a un upper part which comprises a grid and a lower part which comprises collapsible flaps.

The apparatus further comprises a binder reservoir (27) connected to a printhead reservoir (30) for delivering a liquid reagent which is applied on the respective powder layers by means of print head (26). At least 75% of the space comprised between the upper portions of the outer wall and the inner wall of the build chamber (1) comprises a mesh which is in direct contact with the powder recovery system, so that via the upper (top) boundary of the build chamber (1), unused (overflow) is recycled to the powder spreading system. The powder recovery system is covered by a porous cover which also surrounds the build chamber, such that powder overflow during recoating is easily captured. The apparatus is further provided with means (25) for curing the article to be built.

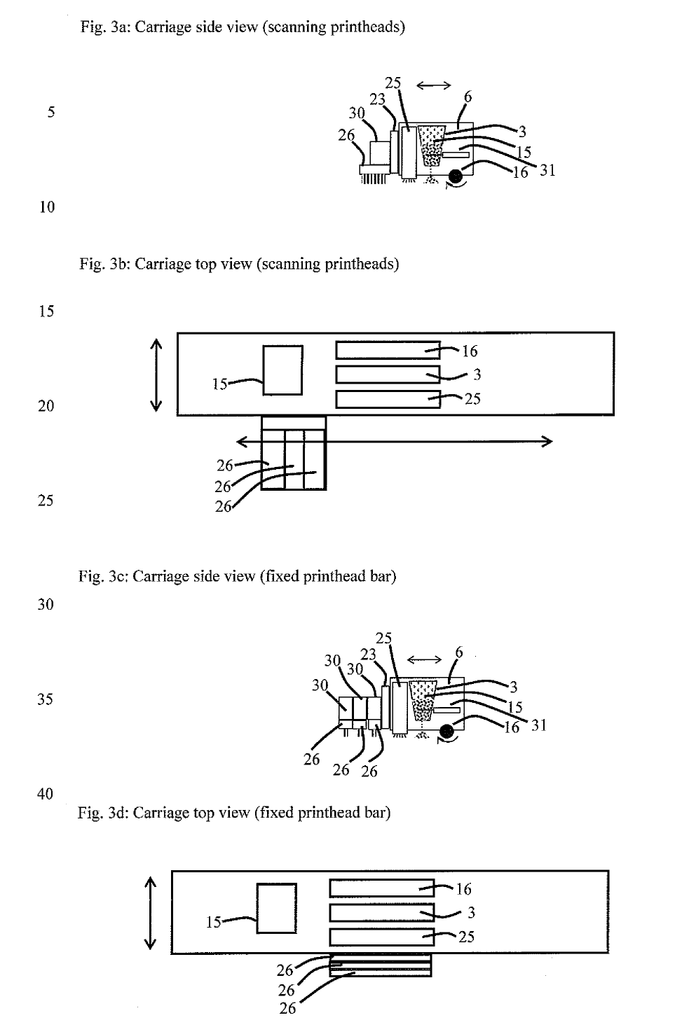

FIGS. 3a and 3b show the carriage equipped with scanning printheads.

FIGS. 3c and 3d show a carriage with fixed printhead bar.

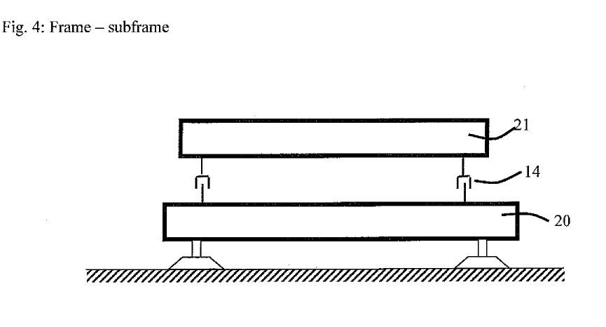

Explanation of FIG. 4; vibrations transmitted from the machine frame into the build chamber can disturb the powder layers in the building chambers during the production of a three dimensional part. Also the vibrations generated from the moving print head will generate high accelerations upon the building chamber. To dampen the effect of both types of vibrations and possible other influences from the outside of the machine the build chamber is connected to the printing carriage using a stiff subframe. This subframe is connected to the machine frame using flexible rubber elements that dampen the transfer of vibrations to the subframe. Also vibrations generated by the printheads are dampened by the subframe. All electronics, binder supply and covering is mounted on the machine frame. The carriage with printheads, UV lamp, Powder doser, Powder recycling systems and the build chamber is mounted on the subframe.

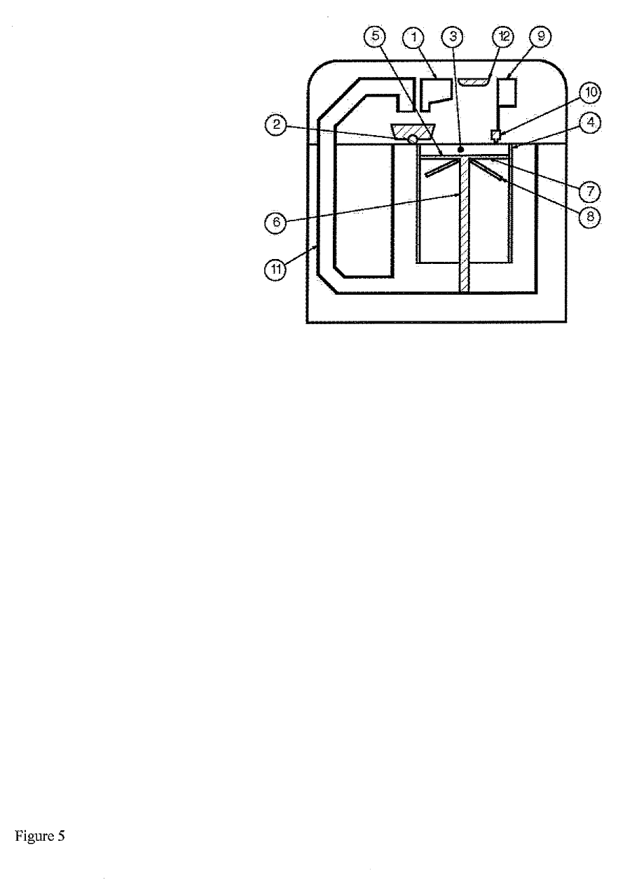

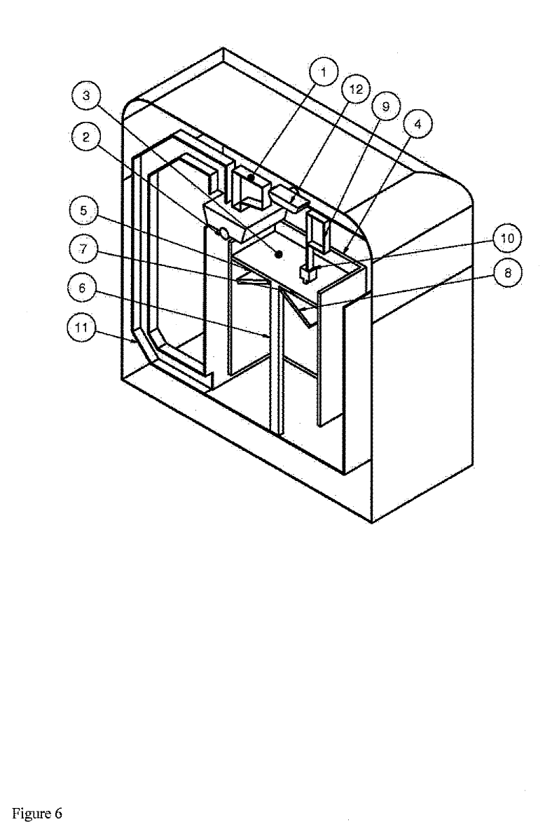

FIGS. 5 and 6 show an apparatus build according to the invention with different design than on FIGS. 1 and 2. The reference numbers used are different than in FIGS. 1 to 4.

FIG. 5 shows a cross-sectional schematic representation of an apparatus according to the present invention. In FIG. 5 the powder delivering system comprises a reservoir for delivering a powder material (1) and a powder spreading system (2) which comprises a roller for applying the powder into the build chamber (3). The build chamber (3) comprises a wall (4) and a build platform (5) which is movable along the inner wall of the build chamber by means of piston (6). The build platform is made up of a un upper (top) part (7) which comprises a grid and a lower part (8) which comprises collapsible flaps. The apparatus further comprises a reservoir (9) for delivering a liquid reagent which is applied on the respective powder layers by means of print head (10). At least 75% of the outer wall of the build chamber (3) is in direct contact with a powder recovery system (11), via the upper (top) boundary of the build chamber (3) which ensures that unused (overflow) is recycled to the powder spreading system (2). The apparatus is further provided with means (12) for curing the article to be built. In FIG. 6, a three-dimensional cross-sectional representation is shown of the apparatus depicted in FIG. 1.

It will be clear from the Figures that the present invention may provide a simple apparatus which will allow for a most efficient re-use of unused powder material.

Further, the manufacture of an end-usable rapid manufactured article can attractively be realised when use is made of the apparatus according to the present invention.

In practice the method in accordance with the present invention can, for instance, be carried out as follows:

A print job consisting of a stack of slices (in bitmap/tiff or other format) that have been prepared by a computer system can be loaded to the machine software. This can consist of a stack of slices (in bitmap/tiff or other format) prepared by a computer system. The input for the software to be used can be a 3D Geometry CAD file. The computer system can input 3D colourless geometric data as STL file (both ASCII and Binary STL models can be used) from a 3D CAD file. The software can then output a series of 2D bitmaps in a specified buffer-directory, whereby each layer that can be printed on the 3D colour printer will correspond with a separate bitmap in the buffer. The bitmaps can store RGB colouring information of at least 16 bit (65536 colours), and they may be able to have a resolution of minimal 300 DPI. The 3D coloured model can be sliced in z direction. The machine software (printer driver) can strip every image in sub-images and can set the sub-images ready for the system. The system can be capable of stacking multiple parts in one job-file consisting of bitmaps. Every bitmap may consist of one slice, which will be fed into the machine.

Subsequently, the powder bed will be prepared. The movable horizontal building platform will carry the powder and liquid reagent from which the article will be made. The movable build chamber is able to release the unused powder by opening flaps of the build platform. In this way unused powder is passed to the powder recovery system. The article that has been built can be taken out of the build chamber at the top. The unused powder will be recycled and re-used via the powder recovery system.

During the powder bed preparation function, the powder can be dispersed over the build platform by a hopper carriage which may comprise a counter rotating roller for optimal spread of the powder over the powder bed. The excessive/overload powder is pushed over the rim or the side of the building platform onto the porous surround which filters the excess powder into powder recovery system. The present construction facilitates a most efficient re-use of unused powder. The unused powder can be transported to the hopper carriage manually or in an automatic mode.

After preparation of the computer file and powder bed, the liquid reagent printing operation starts. A product is split up into a stack of cross sections with a predetermined thickness (also named the print slices) which are sent one after the other to the print head controller. The printer driver translates the digital information into printer carriage movement information and moves to the first line and prints all of the sub-images building the first image part. Subsequently, the print head moves back to the ‘begin’ position on the carriage and loops until the image is fully printed. When completed, the print carriage moves back to its home position and a fresh layer can be deposited. The printing operation may comprise printing with multiple print heads so as to provide liquid reagents with different colours (e.g. cyan, magenta, yellow and black) or liquid reagents that cure differently over time. Each print head will be supplied with liquid reagent by an individual reservoir.

If electromagnetic radiation is used to trigger curing reactions, then prior to the irradiation (which is conducted after each layer is deposited and printed), the print heads will be moved to a standby position in a shutter closed box to prevent that the print heads will be cured by means of stray electromagnetic irradiation. The electromagnetic irradiation source will be switched on for a number of seconds, after which the layer recoating process will be repeated until the final particle is obtained.

It is clear that such an apparatus can be assembled according to individual customer request. For example, the apparatus could have more than one resin dispensing print head, going onto the same powder, in order to achieve an article which can have variable colour, mechanical, optical and electrical properties, such as stiffness, toughness, transparency and conductivity, or a combination thereof. These properties can be varied in macro areas (i.e. greater than, for instance, 1 cm²) or can be varied in a micro manner, such that individual resin droplets differ in all x,y,z directions. In this respect reference can, for instance, be made to WO 03016030.

1. An apparatus for building a three-dimensional article in sequential cross-sectional layers, which apparatus comprises:
a powder delivery system comprising one or more reservoirs for delivering a powder and a powder spreading system;
a printing system for delivering a liquid;
a build chamber comprising an upper portion, a bottom portion, an inner wall and a build platform on the bottom structure which platform is movable along the inner wall of the build chamber;
and a powder recovery system;
wherein the build platform of the build chamber has openable, collapsible or removable parts capable of releasing unused powder directly from the build chamber in a downward direction into the powder recovery system and the build chamber comprises an outer wall and, on the upper portion of the build chamber, the space between the inner wall and the outer wall comprises openings in communication with the powder recovery system.

2. An apparatus according to claim 1, wherein the build chamber is enclosed within the powder recovery system.

3. An apparatus according to claim 1, wherein more than 25% of the space between the upper portions of the inner wall and the outer wall is in communication with the powder recovery system.

4. An apparatus according to claim 1, wherein at least 50% of the said space is in communication with the powder recovery system.

5. An apparatus according to claim 1, wherein at least 75% of the said space is in communication with the powder recovery system.

6. An apparatus according to claim 1, wherein the communication between the said space and the powder recovery system is direct.

7. An apparatus according to claim 1, wherein the printing system comprises one or more nozzles.

8. An apparatus according to claim 7, wherein a plurality of nozzles form part of an inkjet printer or a device including a set of nozzles generally equivalent to an inkjet print head.

9. An apparatus according to claim 8, wherein the nozzles operate on the principles of piezo inkjet technology.

10. An apparatus according to claim 1, wherein the printing system comprises two or more print heads.

11. An apparatus according to claim 1, wherein the powder delivery system comprises a plurality of reservoirs for delivering a powder.

12. An apparatus according to claim 1, wherein the build platform comprises an upper structure provided with openings and a bottom structure that can be opened or removed to release unused powder through the openings of the upper structure.

13. An apparatus according to claim 12, wherein the upper structure comprises a mesh tray, a grill, a grid, or a louvered structure.

14. An apparatus according to claim 13, wherein the bottom structure comprises parts which are openable, collapsible or removable.

15. An apparatus according to claim 1, which further comprises a means for curing the article to be built.

16. An apparatus according to claim 15, wherein the means for curing the article to be built is an electromagnetic radiation-based system.

17. An apparatus according to claim 1, wherein the powder recovery system comprises a conduit for transporting unused powder and a powder carrier screw for moving unused powder through the conduit or it comprises a conduit for transporting unused powder and a vacuum pump for moving unused powder through the conduit.

18. An apparatus according to claim 1, wherein the powder recovery system comprises a filter or a sieve for filtering or sieving unused powder.

19. An apparatus according to claim 1, wherein the printing system and the powder spreading system are connected to the same guiding means.

20-28. (canceled)

29. An apparatus according to claim 1, wherein the build chamber is connected to the printing carriage using a subframe.

30. An apparatus according to claim 29, wherein printheads extend on the full width of the space located between the inner walls of the building chamber.

31. A method for building a three-dimensional article in sequential cross-sectional layers in accordance with a model of the article, which method comprises the steps of:
(i) providing an apparatus according to claim 1;
(ii) defining a layer of a powder material in the apparatus;
(iii) applying a liquid reagent to the layer of powder material so defined, in a pattern corresponding to the respective cross-sectional layer of the model;
(iv) repeating these steps to form successive layers so as to obtain a three-dimensional article;
(v) optionally curing the three-dimensional article thus obtained; and
(vi) recovering the three-dimensional article from the apparatus.

32. A method according to claim 31, wherein the powder material comprises a first reactive component and the liquid reagent comprises a second reactive component, the second reactive component being capable of either reacting with the first reactive component or facilitating the first reactive component to react with itself

33. A method according to claim 31, wherein the model is a digital model.

34. A method according to claim 31, wherein at least one of the layers of powder material comprises a different type of powder material than other layer(s).

35. A method according to claim 31, wherein a plurality of different liquid reagents is applied to at least one layer of powder material.

36. A method according to claim 31, wherein the different liquid reagents are applied in a single pass.

37. A method according to claim 31, wherein the different liquid reagents are applied in sequential passes.

38. A method according to claim 31, wherein the liquid reagent further comprises a viscosity lowering diluent.

39. A method according to claim 31, wherein in the powder recovery system an under pressure is applied.
